(19) United States
(12) Patent Application Publication
(10) Pub. No.: US 2021/0351657 A1
(43) Pub. Date: Nov. 11, 2021

(54) MOTOR

(71) Applicant: NIDEC CORPORATION, Kyoto (JP)

(72) Inventors: Yuki NORIKANE, Kyoto (JP); Hiroshi SAMBUICHI, Kyoto (JP); Takayuki MIGITA, Kyoto (JP)

(21) Appl. No.: 17/285,091

(22) PCT Filed: Oct. 19, 2019
(86) PCT No.: PCT/JP2019/041231

§ 371 Date: Apr. 14, 2021

(30) Foreign Application Priority Data
Oct. 19, 2018 (JP) 2018-197313
Oct. 19, 2018 (JP) 2018-197314

(51) Int. Cl. H02K 5/173; H02K 5/22; H02K 11/33

(52) U.S. Cl. CPC H02K 5/1735; H02K 2211/03; H02K 11/33; H02K 5/225

(57) ABSTRACT

A motor includes a housing, a bearing holder, and a lid. The housing includes a tubular housing body having an end portion at one side, a recessed portion recessed from the end portion toward the other side, a housing protrusion extending from a bottom surface of the recessed portion toward the one side, a stepped portion on the one side away from the housing protrusion, and an extension extending from an opening toward the one side. The bearing holder includes a bearing protrusion extending radially outward, disposed in the recessed portion, and fixedly crimped between the housing protrusion and a side surface constituting the recessed portion. The lid is in axial contact with the stepped portion, and the extension is crimped onto the lid. Between the lid and the housing protrusion, an axial gap is formed, and between the housing protrusion and the side surface, a circumferential gap is formed.

### CROSS-REFERENCE TO RELATED APPLICATIONS

This is the U.S. national stage of application No. PCT/JP2019/041231, filed on Oct. 19, 2019, and priority under 35 U.S.C. § 119(a) and 35 U.S.C. § 365(b) is claimed from Japanese Patent Application No. 2018-197313, filed on Oct. 19, 2018 and Japanese Patent Application No. 2018-197314, filed on Oct. 19, 2018, the disclosures of which are incorporated herein by reference.

### FIELD OF THE INVENTION

The present invention relates to a motor.

### BACKGROUND

A conventional motor includes a tubular housing, a bearing holder for holding a bearing, and a lid part for covering an opening of the housing. The bearing holder has a plate shape and is housed inside the housing. The bearing holder is fixed to the housing, for example, by crimping. The lid part has a plate shape and is fixed to the housing, for example, by crimping.

Unfortunately, when the two members, the bearing holder and the lid part, are attempted to be fixed to the housing, crimping between the housing and one of the members may affect crimping between the housing and the other member.

### SUMMARY

An exemplary motor according to an embodiment of the present invention includes a rotor having a shaft disposed along a center axis, a stator disposed radially outside the rotor, a housing that houses the rotor and the stator and has an opening that opens on one axial side, a bus bar holder made of resin, being disposed on the one axial side of the stator to close the opening, a bearing holder disposed on the one axial side of the bus bar holder, a bearing held by the bearing holder, and a lid part located on the one axial side of the bearing holder, covering the bearing holder. The housing includes a housing body in a tubular shape extending axially, a first housing recessed portion recessed from an end portion of the housing body on the one axial side toward another axial side, a housing protrusion extending from a bottom surface of the first housing recessed portion toward the one axial side, a stepped portion formed inside the opening and located away from the housing protrusion toward the one axial side, and a housing extension portion extending from the opening toward the one axial side. The bearing holder includes at least one bearing protrusion extending radially outward from a radially outer end portion of the bearing holder. At least a part of the at least one bearing protrusion is disposed in the first housing recessed portion, and is fixed by being crimped between the housing protrusion and a side surface constituting the first housing recessed portion. The lid part is in axial contact with the stepped portion and the housing extension portion is crimped onto the lid part while forming an axial gap between the lid part and the housing protrusion, and a circumferential gap is formed between the housing protrusion and the side surface constituting the first housing recessed portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view of a motor according to an embodiment of the present invention;

FIG. 2 is a perspective view of a stator according to the embodiment of the present invention;

FIG. 3 is a partially enlarged view of an insulator according to the embodiment of the present invention;

FIG. 4 is a perspective view of a bus bar holder according to the embodiment of the present invention;

FIG. 5 is a diagram illustrating a state in which the bus bar holder is combined with the insulator in the embodiment of the present invention;

FIG. 6 is a partially enlarged view of a housing according to the embodiment of the present invention;

FIG. 7 is a diagram illustrating a state in which a bearing holder and the housing in the embodiment of the present invention are fixed;

FIG. 8 is a perspective view of the bearing holder according to the embodiment of the present invention;

FIG. 9 is a perspective view of the stator and the bus bar holder according to the embodiment of the present invention;

FIG. 10 is a perspective view of a mold stator according to the embodiment of the present invention;

FIG. 11 is a perspective view of a state in which the bearing holder is combined with the housing in the embodiment of the present invention; and

FIG. 12 is a perspective view of a state in which a circuit board is combined with the motor in the embodiment of the present invention.

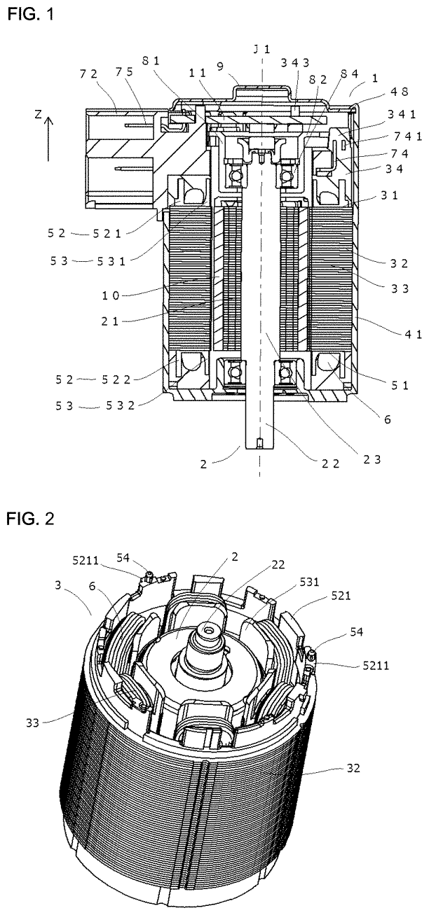

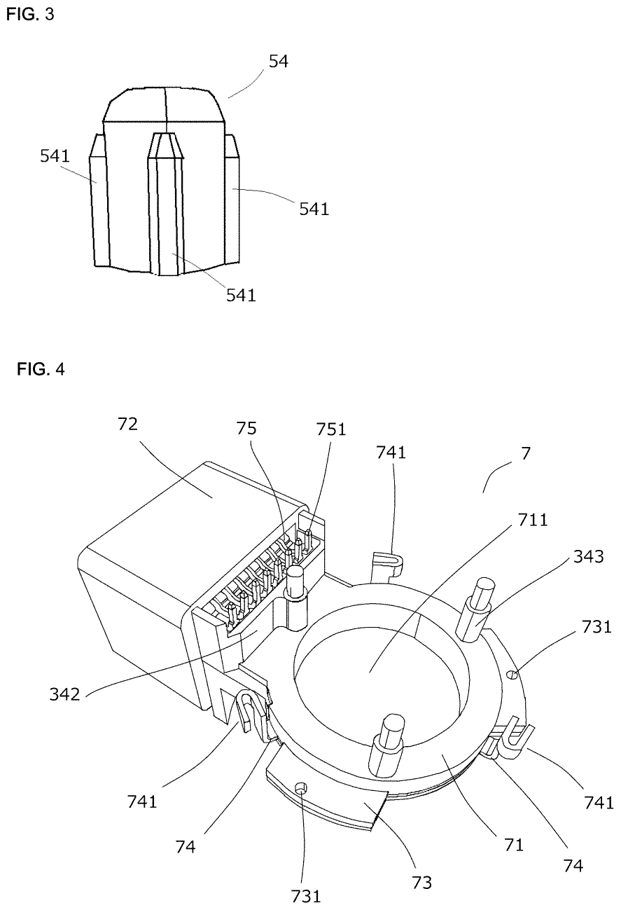

### DETAILED DESCRIPTION

Hereinafter, a motor according to an embodiment of the present invention will be described with reference to the accompanying drawings. In the following drawings, each structure may be different in contraction scale, number, or the like from an actual structure for easy understanding.

Each of the drawings indicates Z-axis. Each of the drawings appropriately indicates a center axis J1 that is a virtual line extending parallel to a Z-axis direction. In the following description, an axial direction of the center axis J1, i.e., a direction parallel to the Z-axis direction, is simply referred to as “axial direction”, a radial direction about the center axis J1 is simply referred to as “radial direction”, and a circumferential direction about the center axis J1 is simply referred to as “circumferential direction”.

In the present specification, a positive side in the Z-axis direction in the axial direction may be referred to as “upper side”, and a negative side in the Z-axis direction in the axial direction may be referred to as “lower side”. The terms, the vertical direction, the upper side, and the lower side, are used only for description, and do not limit an actual positional relation or an attitude of a motor when the motor is used.

In the present embodiment, a motor 1 includes a rotor 2, a stator 3, a housing 4, and a bus bar holder 7. The rotor 2 includes a shaft 22 disposed along the center axis J1. The stator 3 is disposed radially outside the rotor 2. The housing 4 is a tubular member extending along a direction of the center axis J1. The housing 4 houses the rotor 2 and the stator 3, and has an opening that opens on one axial side. Inside the housing 4, the rotor 2, the stator 3, and the bus bar holder 7 are housed. The bus bar holder 7 is located on the one axial side of the stator 3 and holds a bus bar 74. The bus bar holder 7 is made of resin and is disposed on the one axial side of the stator 3 to close the opening.

The rotor 2 includes a rotor core 21, multiple magnets 10, and a shaft 22. In the present embodiment, the rotor core 21 is a member in which multiple electromagnetic steel plates are laminated. The multiple magnets 10 are disposed side by side in the circumferential direction on an outer peripheral surface of the rotor core 21. The magnets 10 are each fixed to the outer peripheral surface of the rotor core 21 by, for example, adhesion, injection molding using a resin, using a rotor cover covering the rotor core 21, or the like. The shaft 22 is a substantially columnar member. The shaft 22 extends along the direction of the center axis J1. The rotor core 21 has a shaft hole 23 passing through the rotor core 21 in the axial direction. The shaft 22 is fixed in the shaft hole 23 by, for example, press fitting. The shaft 22 may be inserted into and fixed in the shaft hole 23 using a member such as resin. That is, the shaft 22 is directly or indirectly fixed to the rotor core 21.

The stator 3 is substantially annular. The rotor 2 is located radially inside the stator 3. The rotor 2 is rotatable against the stator 3 with respect to the center axis J1. The stator 3 includes a stator core 31, a coil 6, and an insulator 5.

The stator core 31 is a member in which electromagnetic steel sheets are laminated in the axial direction. The stator core 31 includes a core back 32 in a substantially annular shape and multiple teeth 33 extending radially inward from an inner surface of the core back 32. That is, the stator 3 includes the core back 32, the teeth 33, the insulator 5, and the coil 6. The multiple teeth 33 are disposed at intervals in the circumferential direction. The core back 32 may be formed by disposing multiple divided pieces in an annular shape, or may be composed of multiple pieces in which some pieces are connected.

The insulator 5 is a member having insulating properties. In the present embodiment, material of the insulator 5 is resin having insulating properties. The insulator 5 is attached to each of the teeth 33. The insulator 5 includes a tubular portion 51, an inner wall portion 53, and an outer wall portion 52. The tubular portion 51 has a tubular shape. The teeth 33 pass through inside the tubular portion 51. That is, an outer peripheral surface of the teeth 33 is covered with the tubular portion 51. The tubular portion 51 is provided with a first inner wall portion 531 and a second inner wall portion 532, being disposed radially inside. The tubular portion 51 is provided with a first outer wall portion 521 and a second outer wall portion 522, extending axially and being disposed radially outside. The first inner wall portion 531 extends axially upward on an upper surface of the tubular portion 51. The second inner wall portion 532 extends axially downward on a lower surface of the tubular portion 51. The first outer wall portion 521 extends axially upward on the upper surface of the tubular portion 51. That is, the first outer wall portion 521 extends from the radial outside of the tubular portion 51 on the one axial side toward the one axial side. The second outer wall portion 522 extends axially downward on the lower surface of the tubular portion 51.

The coil 6 is disposed around the tubular portion 51. That is, the coil 6 is disposed on the teeth 33 with the insulator 5 interposed therebetween. The coil 6 is formed by, for example, winding a conducting wire around the tubular portion 51. In the present embodiment, the motor 1 is a three-phase motor having U-phase, V-phase, and W-phase. The coil 6 includes a U-phase conducting wire forming a U-phase coil group, a V-phase conducting wire forming a V-phase coil group, and a W-phase conducting wire forming a W-phase coil group. Each of the conducting wires has an end portion that is drawn axially upward.

A dimension between the tubular portion 51 and an upper end surface of the coil 6 is preferably shorter than axial dimensions of the first and second inner wall portions 531 and 532. The dimension between the tubular portion 51 and the upper end surface of the coil 6 is preferably shorter than axial dimensions of the first and second outer wall portions 521 and 522. This prevents the coil 6 from being separated from the tubular portion 51 even when an impact or the like is applied to the motor 1 from the outside.

The first outer wall portion 521 of one insulator 5 of multiple insulators 5 includes a pin 54 extending axially upward from an upper end portion of the first outer wall portion 521. That is, the pin 54 extends from one axial end portion of the first outer wall portion 521 toward the one axial side. In the present embodiment, the first outer wall portion 521 is provided on the one axial end portion with an outer protrusion 5211 protruding radially outward. The pin 54 extends from the first outer wall portion 521 and the outer protrusion 5211 toward the one axial side. This enables providing a pin with a larger diameter.

The pin 54 includes multiple ribs 541 extending axially. The ribs 541 are disposed at intervals along an outer peripheral surface of the pin 54. In other words, at least one rib 541 extending axially is formed on the outer surface of the pin 54.

The bus bar holder 7 is disposed axially above the stator 3. The bus bar holder 7 includes a main body portion 71 and a connector portion 72.

In the present embodiment, the main body portion 71 is a tubular member extending axially. The main body portion 71 includes a central hole 711 passing through the main body portion 71 in the axial direction. Material of the main body portion 71 is an insulating resin. The main body portion 71 is disposed on the one axial side of the opening. The main body portion 71 includes at least one flange portion 73 extending radially outward. In the present embodiment, the main body portion 71 includes multiple flange portions 73 disposed at intervals in the circumferential direction. In the present embodiment, two flange portions 73 are provided. Each of the flange portions 73 extends in the circumferential direction.

In the present embodiment, the main body portion 71 has an outer surface located radially inside an outer surface of the core back 32. That is, the outer surface of the main body portion 71 is located radially inside an outer surface of the stator 3. This enables the motor 1 to be prevented from increasing in radial dimension. The main body portion 71 is located axially above the coil 6. When viewed axially, a gap is formed between the outer surface of the main body portion 71 and the outer surface of the stator 3 in the radial direction. This enables a leader wire drawn from the coil 6 to pass through the gap between the outer surface of the main body portion 71 and the outer surface of the stator 3. When viewed axially, the coil 6 or a slot gap is located between the core back 32 and the main body portion 71 in the radial direction. The flange portions 73 are located axially above the core back 32. A gap is formed between the flange portions 73 adjacent to each other. Each of the flange portions 73 includes a flange hole 731 passing through the corresponding one of the flange portions 73 axially. In the present embodiment, an angle θ of 120 degrees is formed between flange holes 731 of the respective flange portions 73 adjacent to each other with respect to the center axis J1.

The connector portion 72 is a tubular portion. The connector portion 72 extends radially outward from the main body portion 71. That is, the connector portion 72 projects radially outward from the main body portion 71. Material of the connector portion 72 has insulating properties. In the present embodiment, the material of the connector portion 72 is a resin having insulating properties. For example, a connection terminal for an external power supply is attached to the connector portion 72. When viewed axially, a space is formed between the connector portion 72 and the flange portion 73 in the circumferential direction.

The bus bar holder 7 includes multiple bus bars 74. The bus bars 74 are each an electrically conductive member. In the present embodiment, material of the bus bars 74 is an electrically conductive metal. At least a part of each of the bus bars 74 is located inside the main body portion 71 and the connector portion 72. That is, the bus bar holder 7 holds the bus bars 74. In other words, at least part of each of the bus bars 74 is covered with resin. Each of the bus bars 74 includes multiple terminal connection portions and multiple coil connection portions 741. The terminal connection portions are located inside the connector portion 72. When viewed radially, the terminal connection portions are exposed inside the connector portion 72.

In the present embodiment, the bus bar holder 7 further includes a sensor connector 75 held by the connector portion 72. The sensor connector 75 includes a circuit-board connection portion 751 that is exposed from a radially inner end portion of the connector portion 72 and is connected to a circuit board 11 described later. As with the bus bars 74, the sensor connector 75 includes a connector-terminal connection portion that is located inside the connector portion 72 and is exposed inside the connector portion 72 when viewed radially.

In the present embodiment, the coil connection portions 741 are each in a substantially U-shape when viewed axially. When viewed axially, a leading end of each of the coil connection portions 741 faces one circumferential side.

When viewed axially, at least one of the coil connection portions 741 is located in a space between the flange portions 73 adjacent to each other in the circumferential direction. At least one of the coil connection portions 741 is located in a space between the connector portion 72 and the corresponding one of the flange portions 73 in the circumferential direction.

As described above, the leader wire drawn from the coil 6 is allowed to pass through the space between the flange portions 73 adjacent to each other in the circumferential direction and the space between the connector portion 72 and the corresponding one of the flange portions 73 in the circumferential direction. That is, when viewed axially, a part of each of the bus bars 74 is located in the space between the corresponding flange portions 73 in the circumferential direction. The leader wire is electrically connected to the coil connection portions 741 exposed from the bus bar holder 7. That is, the coil connection portions 741 are electrically connected to the leader wire drawn from the coil 6. The coil connection portions 741 are each connected to the leader wire by, for example, welding or soldering. This enables the leader wire to be connected to the bus bars 74 while preventing increase in radial dimension of the motor 1.

When viewed radially, the flange portions 73 are located axially above the corresponding insulators 5. More specifically, at least a part of an upper axial portion of the first outer wall portion 521 of each of the insulators 5 is covered with the corresponding one of the flange portions 73. That is, at least one of the flange portions 73 extends radially outward and is located on the one axial side of the first outer wall portion 521. In the circumferential and radial directions, the flange hole 731 is located substantially aligned with the pin 54 of the first outer wall portion 521. The pin 54 is inserted into the flange hole 731. This enables the bus bar holder 7 to be prevented from rotating in the circumferential direction.

More preferably, the pin 54 is press-fitted into the flange hole 731. When the pin 54 is inserted into the flange hole 731, the rib 541 disposed on the outer peripheral surface of the pin 54 is elastically or plastically deformed, and then at least one of an outer peripheral surface of the rib 541 and an inner peripheral surface of the flange hole 731 presses the other. This causes the pin 54 to be held in the flange hole 731.

In the present embodiment, the coil 6, the insulator 5, and the coil connection portion 741 are covered with resin. In other words, at least a part of the stator 3 and at least a part of the bus bar holder 7 are covered with resin. That is, at least a part of the stator 3 and at least a part of the bus bar holder 7 are covered with a stator resin portion 34. More specifically, one axial end portion of the stator 3 and the main body portion 71 of the bus bar holder 7 are covered with the stator resin portion 34. At this time, the coil connection portion 741 is covered with the stator resin portion 34. That is, the stator resin portion 34 includes a resin protruding portion 341 covering the coil connection portion 741. This enables the stator 3 and the bus bar holder 7 to be prevented from coming into contact with the housing 4 and a bearing holder 8 described later and causing a short circuit. The stator 3 and the bus bar holder 7 are covered with resin, and thus the stator 3 and the bus bars 74 can be prevented from coming into contact with water, dust, and the like.

In the present embodiment, the stator 3, the bus bar holder 7, and the stator resin portion 34 constitute a mold stator 12. The mold stator 12 is a member in which the stator resin portion 34 is formed after the bus bar holder 7 is attached to the stator 3. The mold stator 12 includes a resin wall portion 342 disposed between the circuit-board connection portion 751 and the bearing holder 8 in the radial direction. When the resin wall portion 342 is provided, the sensor connector 75 can be prevented from coming into contact with the bearing holder 8 and causing a short circuit. In the present embodiment, the resin wall portion 342 is provided on the stator resin portion 34. This enables the resin wall portion 342 to be formed at the time of molding the stator resin portion 34, so that a separate short-circuit prevention component is not required. However, the resin wall portion 342 may be provided on the bus bar holder 7. In that case, the resin wall portion 342 can be formed when the bus bar holder 7 is molded. The resin wall portion may have a circuit-board support portion 343 described later. Providing the circuit-board support portion 343 near the circuit-board connection portion 751 enables reducing a load applied to a connection portion between the circuit-board connection portion 751 and the circuit board 11 due to vibration or the like when the motor 1 is driven.

The bearing holder 8 includes a bearing holding portion 81 and a bearing flange portion 82. The bearing holding portion 81 is a tubular portion extending axially. Inside the bearing holding portion 81, a bearing 84 is held. That is, the bearing 84 is held by the bearing holder 8. In the present embodiment, the bearing 84 is a ball bearing. However, the bearing may be a type of bearing other than the ball bearing. The bearing rotatably supports the shaft 22. At least a part of the bearing holding portion 81 is located inside the through hole (central hole 711) of the bus bar holder 7. When the bearing holding portion 81 overlaps at least a part of the bus bar holder 7 in the radial direction, the motor 1 can be prevented from increasing in axial dimension.

In the present embodiment, the bearing holder 8 further includes a connector recessed portion 87. The connector recessed portion 87 is recessed radially inward from a radially outer side of the bearing flange portion 82. The resin wall portion 342 is located in the connector recessed portion 87, and the bearing flange portion 82 and the resin wall portion 342 overlap with each other in the radial direction. This enables the connector portion 72 to be prevented from increasing in radial dimension. That is, the motor 1 can be prevented from increasing in radial dimension.

The bearing flange portion 82 is in an annular shape when viewed axially. The bearing flange portion 82 extends radially outward from an outer surface of the bearing holding portion 81. The bearing flange portion 82 is radially opposed to or in contact with an inner surface of the housing 4. The bearing flange portion 82 is provided in its radially outer end portion with a bearing recessed portion 85 recessed radially inward. That is, the bearing holder 8 includes the bearing recessed portion 85 recessed radially inward from the radially outer side of the bearing flange portion 82.

In the bearing recessed portion 85, a part of the coil connection portion 741 covered with resin and a part of the leader wire connected to the coil connection portion 741 covered with resin are disposed. That is, a part of the resin protruding portion 341 is disposed in the bearing recessed portion 85, and the bearing recessed portion 85 and the resin protruding portion 341 overlap with each other in the radial direction. The part of the leader wire connected to the coil connection portion 741 covered with resin and the other coil connection portion 741 covered with resin is located axially above the bearing flange portion 82. In other words, the part of the resin protruding portion 341 is located on the one axial side away from the bearing flange portion 82. This enables the motor 1 to be prevented from increasing in axial dimension. The leader wire connected to the coil connection portion 741 and the other coil connection portion 741 has an end portion covered with the resin protruding portion 341, so that the end portion can be prevented from coming into contact with the housing 4 and the bearing holder 8, and causing a short circuit.

The bearing holder 8 includes at least one pair of bearing protrusions 831 and 832, extending radially outward from its radially outer end portion. In the present embodiment, the at least one pair of bearing protrusions 831 and 832 includes a first bearing protrusion 831 and a second bearing protrusion 832 located on the other circumferential side of the first bearing protrusion 831. The at least one pair of bearing protrusions 831 and 832 extending radially outward is formed at respective sides of an opening of the bearing recessed portion 85 in the circumferential direction. The at least one pair of bearing protrusions includes the first bearing protrusion 831 located on the one circumferential side that is located circumferentially away from the second bearing protrusion 832 of the at least one pair of bearing protrusions, being located on the other circumferential side. That is, the bearing recessed portion 85 is located between the pair of first bearing protrusion 831 and the second bearing protrusion 832 in the circumferential direction.

As described above, the housing 4 includes a housing body 41 in a tubular shape that extends axially. In the present embodiment, the housing body 41 has a substantially cylindrical shape. The housing 4 further includes a first housing recessed portion 42, and first and second housing protrusions 46 and 47. The housing body 41 is provided with a second housing recessed portion 43, the first housing recessed portion 42, a housing extension portion 48, and a stepped portion 45. The second housing recessed portion 43 is located in an outer surface of the housing body 41, and is recessed axially downward from an end potion of an opening provided on an upper axial side of the housing body 41. The second housing recessed portion 43 is also a through-hole passing through radially. When the bus bar holder 7 is housed in the housing body 41, the connector portion 72 passes through inside the second housing recessed portion 43.

The first housing recessed portion 42 is recessed axially downward from the end portion of the opening provided on the upper axial side of the housing 4. That is, the first housing recessed portion 42 is recessed from an end portion of the housing body 41 on one axial side toward the other axial side. The first housing recessed portion 42 is also a through-hole that passes through an outer wall of the housing 4 in the radial direction.

Inner surfaces constituting the first housing recessed portion 42 include a bottom surface located downward in the axial direction and side surfaces located on respective sides in the circumferential direction. The bottom surface is formed continuously with the side surfaces.

The bottom surface is provided with the pair of housing protrusions 46 and 47 extending axially upward. That is, the first and second housing protrusions 46 and 47 extend from the bottom surface of the first housing recessed portion 42 toward the one axial side. The pair of the first and second housing protrusions 46 and 47 extend away from each other in the circumferential direction. That is, the first housing protrusion 46 of the pair of the first and second housing protrusions 46 and 47 extends toward the one circumferential side, and the second housing protrusion 47 thereof extends toward the other circumferential side. That is, the first housing protrusion 46 faces the side surface on the one circumferential side of the side surfaces constituting the first housing recessed portion 42. The second housing protrusion 47 faces the side surface on the other circumferential side of the side surfaces constituting the first housing recessed portion 42. The first housing protrusion 46 faces the second housing protrusion 47. A space is formed between the first housing protrusion 46 and the second housing protrusion 47 in the circumferential direction.

The first housing protrusion 46 has an axially lower portion that is connected to an axially lower portion of the second housing protrusion 47. In other words, when viewed radially, the pair of the first and second housing protrusions 46 and 47 extending from the bottom surface has a bifurcated shape (V-shape).

The first housing protrusion 46 is connected to the bottom surface in a portion in which a first slit 461 recessed toward the other circumferential side is formed. Similarly, the second housing protrusion 47 is connected to the bottom surface in a portion in which a second slit 462 recessed toward the one circumferential side is formed. When the first slit 461 and the second slit 462 are formed, the first housing protrusion 46 and the second housing protrusion 47 can be easily opened in the circumferential direction. That is, processing at the time of crimping is facilitated.

The bottom surface is connected to the side surface on the one circumferential side in a portion in which a first bottom surface recessed portion 421 recessed axially downward is formed. Similarly, the bottom surface is connected to the side surface on the other circumferential side in a portion in which a second bottom surface recessed portion 422 recessed axially downward is formed.

The bottom surface between the first bottom surface recessed portion 421 and the first slit 461 in the circumferential direction is provided with a first bottom surface protrusion 423 that protrudes axially upward. Similarly, the bottom surface between the second bottom surface recessed portion 422 and the second slit 462 is provided with a second bottom surface protrusion 424 that protrudes axially upward.

Between the first housing protrusion 46 and the side surface on the one circumferential side, the first bearing protrusion 831 is disposed. The first bearing protrusion 831 is sandwiched between the first housing protrusion 46 and the side surface on the one circumferential side. That is, the first bearing protrusion 831 is disposed between the first housing protrusion 46 and the side surface on the one circumferential side of the side surfaces constituting the first housing recessed portion 42. The first bearing protrusion 831 is in axial contact with the first bottom surface protrusion 423. Between the second housing protrusion 47 and the side surface on the other circumferential side, the second bearing protrusion 832 is disposed. That is, the second bearing protrusion 832 is disposed between the second housing protrusion 47 and the side surface on the other circumferential side of the side surfaces constituting the first housing recessed portion 42. The second bearing protrusion 832 is sandwiched between the second housing protrusion 46 and the side surface on the other circumferential side. The second bearing protrusion 832 is in axial contact with the second bottom surface protrusion 424. Each bearing protrusion is in axial contact with the bottom surface. This causes the bearing holder 8 to be positioned not only in the circumferential direction but also in the axial direction against the housing 4.

When the motor 1 is assembled, the first housing protrusion 46 and the second housing protrusion 47 are opened toward respective circumferential sides using a jig. That is, the jig is pressed downward from above in the axial direction into a space between the first housing protrusion 46 and the second housing protrusion 47 in the circumferential direction so that the space between the first housing protrusion 46 and the second housing protrusion 47 is increased in dimension in the circumferential direction. This causes the first bearing protrusion 831 to be sandwiched between the first housing protrusion 46 and the side surface located on the one circumferential side in the circumferential direction, and the second bearing protrusion 832 to be sandwiched between the second housing protrusion 47 and the side surface located on the other circumferential side in the circumferential direction. That is, at least a part of each of the first and second bearing protrusions 831 and 832 is disposed in the first housing recessed portion 42, and is fixed by being crimped between the corresponding the pair of the first and second housing protrusions 46 and 47, and the corresponding one of the side surfaces constituting the first housing recessed portion 42. In other words, each bearing protrusion is fixed by being crimped between the corresponding one of the pair of housing protrusions and the corresponding one of the side surfaces. This causes the bearing holder 8 to be prevented from rotating in the circumferential direction.

The first bearing protrusion 831 may be disposed between the first bottom surface recessed portion 421 and the first bottom surface protrusion 423, inside the first slit 461, or between the first slit 461 and the side surface on the one circumferential side. Similarly, the second bearing protrusion 832 may be disposed between the second bottom surface recessed portion 422 and the second bottom surface protrusion 424, inside the second slit 462, or between the second slit 462 and the side surface on the other circumferential side. That is, in the first housing recessed portion 42, the first bearing protrusion 831 may be located between the first housing protrusion 46 and the side surface located on the one circumferential side. In the first housing recessed portion 42, the second bearing protrusion 832 may be located between the second housing protrusion 47 and the side surface located on the other circumferential side.

As described above, the housing 4 includes the stepped portion 45 and the housing extension portion 48. The housing body 41 is provided on its upper axial side with the opening in which a portion close to the opening (upper axial side) has a larger inner diameter than a portion on its lower axial side. That is, the stepped portion 45 is formed at a boundary between portions different in inner diameter in the opening of the housing 4 on its upper axial side. A portion axially above the stepped portion 45 has a larger inner diameter than a portion located axially below the stepped portion 45. The stepped portion 45 is located axially above the first and second housing protrusions 46 and 47. That is, the stepped portion 45 is formed inside the opening and is located on the one axial side away from the first and second housing protrusions 46 and 47.

The housing extension portion 48 extends axially upward from the end portion of the opening provided on the upper axial side of the housing 4. That is, the housing extension portion 48 extends from the opening toward the one axial side. The housing 4 has the opening in which the housing extension portion 48 has a narrower circumferential width than a portion located radially below the housing extension portion 48. The housing extension portion 48 is adjacent to the second housing recessed portion 43 in the circumferential direction.

The housing body 41 is provided on its upper axial side with the opening to which a lid part 9 is attached. In other words, the lid part 9 is located axially above the bearing holder 8 while covering the bearing holder 8. In the present embodiment, the lid part 9 is a substantially plate-shaped member. Material of the lid part 9 is, for example, metal such as iron. The material of the lid part 9 may be other than metal material.

At least a part of a radially outer end portion of the lid part 9 is radially opposed to or in contact with the inner surface of the housing 4. At least a part of the radially outer end portion of the lid part 9 is in axial contact with the stepped portion 45. That is, the lid part 9 is in axial contact with the stepped portion 45. This allows an axial position of the lid part 9 against the housing 4 to be determined. As described above, the stepped portion 45 is located axially above the first and second housing protrusions 46 and 47. Thus, the lid part 9 is located axially above the first and second housing protrusions 46 and 47. In other words, there is an axial gap between the lid part 9, and the housing protrusions 46 and 47. That is, the axial gap is formed between the lid part 9, and the first and second housing protrusions 46 and 47.

The lid part 9 has an upper surface with which the housing extension portion 48 is in contact. More specifically, when the motor 1 is assembled, the housing extension portion 48 is bent from the radial outside toward the radial inside and comes into contact with the upper surface of the lid part 9. In other words, the housing extension portion 48 is crimped onto the lid part 9. As described above, the lid part 9 comes into axial contact with the stepped portion 45. In the axial direction, there is the gap between the lid part 9, and the first and second housing protrusions 46 and 47. Thus, even when the housing extension portion 48 is bent toward the lid part 9 and comes into contact with the lid part 9, the lid part 9 does not come into contact with the first and second housing protrusions 46 and 47.

As described above, there are gaps between the first and second housing protrusions 46 and 47, and the corresponding side surfaces of the first housing recessed portion 42, the gaps being formed on opposite circumferential sides. In other words, the gaps are formed in the circumferential direction between the first and second housing protrusions 46 and 47, and the corresponding side surfaces constituting the first housing recessed portion 42. Thus, even when the housing extension portion 48 is bent toward the lid part 9 and a portion of the outer wall of the housing 4 having the housing extension portion 48 is deformed in the circumferential direction, the first and second housing protrusions 46 and 47 are prevented from coming into contact with the corresponding side surfaces constituting the first housing recessed portion 42.

Then, even when the housing extension portion 48 and the lid part 9 are fixed by crimping, the crimping is less likely to affect a portion fixed by being crimped between the bearing holder 8 and the housing 4. As a result, even when the housing 4 is fixed to both the bearing holder 8 and the lid part 9 by different crimping positions, deterioration in fixing strength due to each crimping can be reduced. In the present embodiment, an axial gap is formed between the lid part 9 and the bearing holder 8 that are crimped and fixed onto the housing 4. Between the lid part 9 and the bearing holder 8 in the axial direction, the circuit board 11 electrically connected to the motor 1 is disposed. This enables the motor 1 to be prevented from increasing in axial dimension. That is, the circuit board 11 can be supported, and two or more members can be crimped and fixed, while the motor 1 is prevented from increasing in axial dimension.

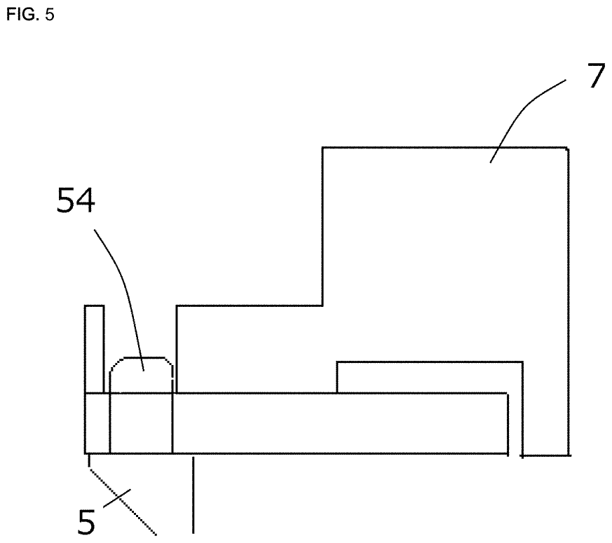

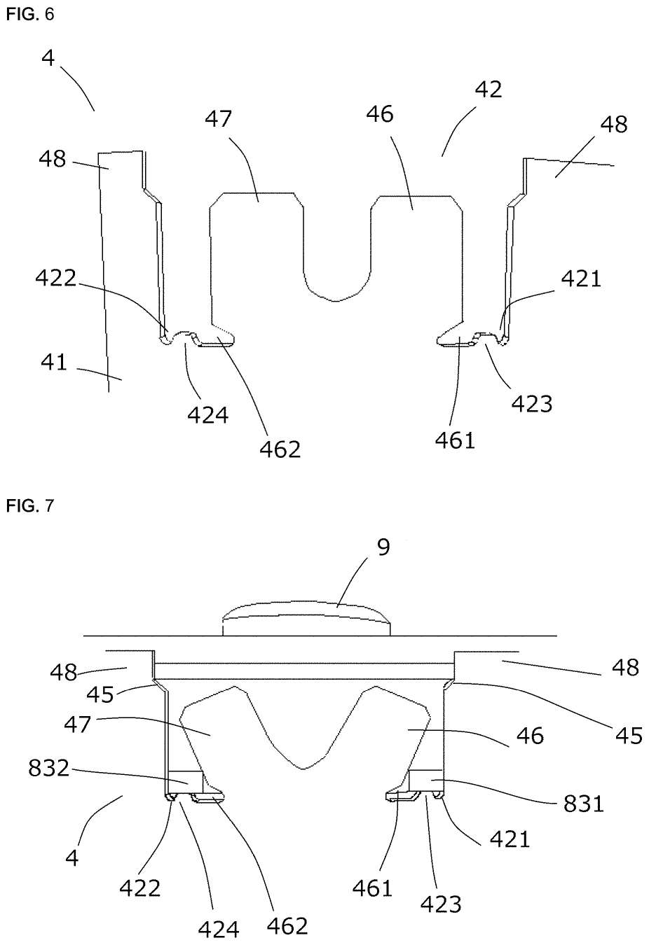

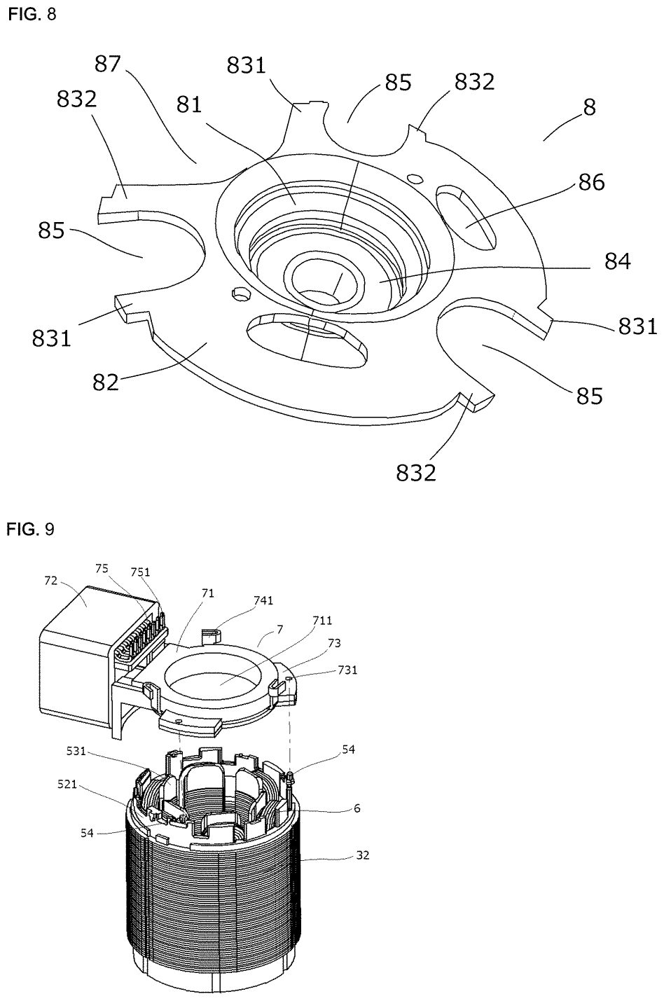

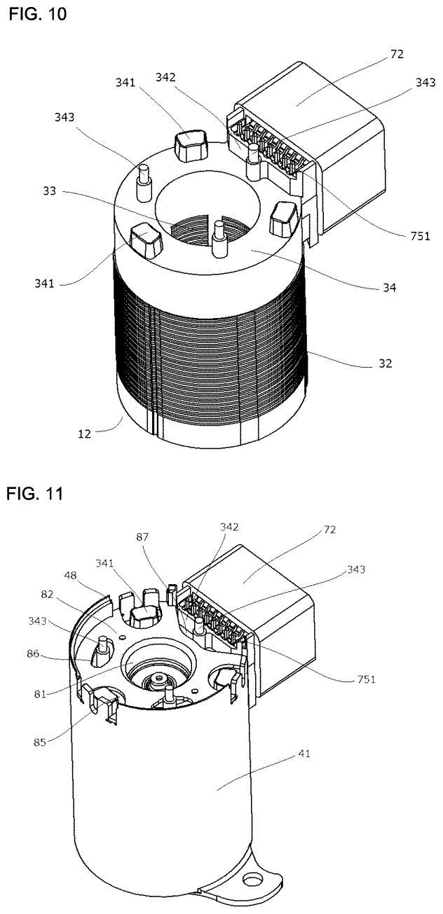

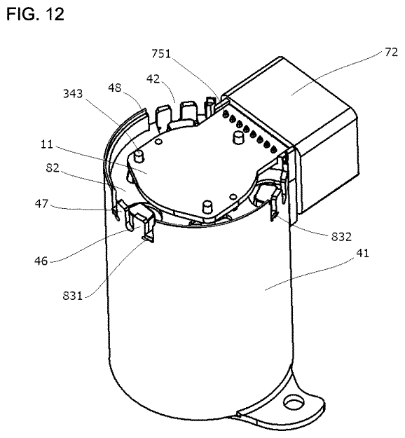

In the present embodiment, the housing extension portion 48 and the lid part 9 are crimped and fixed at four locations in the circumferential direction. However, the number of locations at which the housing extension portion 48 and the lid part 9 are crimped and fixed may be more than four, or less than four. The mold stator 12 includes the circuit-board support portion 343 that projects toward the one axial side and supports the circuit board 11. The circuit-board support portion 343 passes through the bearing holder 8 in the axial direction. Specifically, the bearing flange portion 82 includes a bearing through-hole 86 passing through the bearing flange portion 82 in the axial direction, and the circuit-board support portion 343 passes through the bearing through-hole 86. The circuit-board support portion 343 includes a stepped portion. A portion on the one axial side extending from the stepped portion is inserted into a hole provided in the circuit board 11. Thus, the circuit board 11 is positioned in the axial direction by the stepped portion. This enables the circuit board 11 to be supported between the lid part 9 and the bearing holder 8 in the axial direction without separately providing a member for supporting the circuit board 11. In the present embodiment, the circuit-board support portion 343 is provided on a surface of the bus bar holder 7 on the one axial side as illustrated in FIG. 4. This enables the circuit-board support portion 343 to be formed when the bus bar holder 7 is molded. However, as illustrated in FIG. 10, the circuit-board support portion 343 may be formed on a surface of the stator resin portion 34 on the one axial side. This case enables the circuit-board support portion 343 to be formed when the stator resin portion 34 is molded. In the present embodiment, the circuit-board support portion 343 is located radially inside the resin protruding portion 341. This enables the circuit board 11 to be prevented from increasing in radial dimension.

The motor of the present invention can be used, for example, in applications such as electric brakes, electric power steering, and various home appliances.

Although various embodiments of the present invention have been described above, structures in the respective embodiments and a combination thereof are examples, and thus addition, elimination, replacement of structure, and other modifications can be made within a range without departing from the spirit of the present invention. Then, the present invention is not limited by the embodiments.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor comprising:
a rotor having a shaft disposed along a center axis;
a stator disposed radially outside the rotor;
a housing that houses the rotor and the stator and has an opening that opens on one axial side;
a bus bar holder made of resin, being disposed on the one axial side of the stator to close the opening;
a bearing holder disposed on the one axial side of the bus bar holder;
a bearing held by the bearing holder; and
a lid part located on the one axial side of the bearing holder, covering the bearing holder,
the housing including:
a housing body in a tubular shape extending axially;
a first housing recessed portion recessed from an end portion of the housing body on the one axial side toward another axial side;
a housing protrusion extending from a bottom surface of the first housing recessed portion toward the one axial side;
a stepped portion formed inside the opening and located away from the housing protrusion toward the one axial side; and
a housing extension portion extending from the opening toward the one axial side, the bearing holder including at least one bearing protrusion extending radially outward from a radially outer end portion of the bearing holder,
at least a part of the at least one bearing protrusion being disposed in the first housing recessed portion, and fixed by being crimped between the housing protrusion and a side surface constituting the first housing recessed portion,
the lid part being in axial contact with the stepped portion,
the housing extension portion being crimped onto the lid part while forming an axial gap between the lid part and the housing protrusion, and
a circumferential gap being formed between the housing protrusion and the side surface constituting the first housing recessed portion.

2. The motor according to claim 1, wherein
the housing protrusion includes
a first housing protrusion extending toward one circumferential side and facing a side surface of side surfaces constituting the first housing recessed portion, the side surface being on the one circumferential side, and
a second housing protrusion extending toward another circumferential side and facing a side surface of the side surfaces constituting the first housing recessed portion, the side surface being on the other circumferential side,
the bearing protrusion includes
a first bearing protrusion extending radially outward from a radially outer end portion of the bearing holder, and
a second bearing protrusion extending radially outward from the radially outer end portion of the bearing holder and being located on the other circumferential side away from the first bearing protrusion,
the first bearing protrusion is disposed between the first housing protrusion and the side surface on the one circumferential side of the side surfaces, and
the second bearing protrusion is disposed between the second housing protrusion and the side surface on the other circumferential side of the side surfaces.

3. The motor according to claim 2, wherein
the first housing protrusion has a portion on the other axial side, the portion being connected to a portion of the second housing protrusion, being on the other axial side,
the first housing protrusion has a portion connected to the bottom surface, the portion being provided with a first slit recessed toward the other circumferential side,
the second housing protrusion has a portion connected to the bottom surface, the portion being provided with a second slit recessed toward the one circumferential side, and
at least a part of the first bearing protrusion is located inside the first slit.

4. The motor according to claim 3, wherein
the bottom surface has a portion connected to the side surface on the one circumferential side, the portion being provided with a first bottom surface recessed portion recessed toward the other axial side,
the bottom surface has a portion connected to the side surface on the other circumferential side, the portion being provided with a second bottom surface recessed portion recessed toward the other axial side,
a first bottom surface protrusion is formed between the first bottom surface recessed portion and the first slit, and protrudes toward the one axial side,
a second bottom surface protrusion is formed between the second bottom surface recessed portion and the second slit, and protrudes toward the one axial side,
the first bearing protrusion is in axial contact with the first bottom surface protrusion, and
the second bearing protrusion is in axial contact with the second bottom surface protrusion.

5. The motor according to claim 2, wherein
the bearing holder includes,
a bearing holding portion that is in a tubular shape extending axially, and holds the bearing inside, and
a bearing flange portion extending radially outward from an outer surface of the bearing holding portion, and
at least a part of the bearing holding portion is located inside a central hole of the bus bar holder.

6. The motor according to claim 5, wherein
a circuit board is axially disposed between the lid part and the bearing holder, and is electrically connected to the motor.

7. The motor according to claim 6, wherein
at least a part of the stator and at least a part of the bus bar holder are covered with a stator resin portion.

8. The motor according to claim 7, wherein
the stator, the bus bar holder, and the stator resin portion constitute a mold stator,
the mold stator includes a circuit-board support portion that projects toward the one axial side and supports the circuit board, and
the circuit-board support portion axially passes through the bearing holder.

9. The motor according to claim 8, wherein the circuit-board support portion is provided on a surface of the bus bar holder on the one axial side.

10. The motor according to claim 8, wherein the circuit-board support portion is provided on a surface of the stator resin portion on the one axial side.

11. The motor according to claim 8, wherein
the bearing flange portion includes a bearing through-hole that axially passes through the bearing flange portion, and
the circuit-board support portion passes through the bearing through-hole.

12. The motor according to claim 8, wherein
the bus bar holder holds a bus bar including a coil connection portion that is electrically connected to a lead wire drawn from a coil,
the stator resin portion includes a resin protruding portion covering the coil connection portion, and
a part of the resin protruding portion is located on the one axial side away from the bearing flange portion.

13. The motor according to claim 12, wherein
the bearing holder includes a bearing recessed portion recessed radially inward from a radially outer side of the bearing flange portion, and
a part of the resin protruding portion is disposed in the bearing recessed portion.

14. The motor according to claim 13, wherein the bearing recessed portion is located circumferentially between a pair of the first bearing protrusion and the second bearing protrusion.

15. The motor according to claim 12, wherein
the circuit-board support portion is located radially inside the resin protruding portion.

16. The motor according to claim 8, wherein
the bus bar holder includes
a main body portion disposed on the one axial side away from the opening,
a connector portion projecting radially outward from the main body portion of the bus bar holder, and
a sensor connector held by the connector portion, having a circuit-board connection portion that is exposed from a radially inner end portion of the connector portion and is connected to the circuit board, and
the mold stator includes a resin wall portion that is disposed radially between the circuit-board connection portion and the bearing holder.

17. The motor according to claim 16, wherein the circuit-board support portion projects from the resin wall portion toward the one axial side.

18. The motor according to claim 16 or 17, wherein
the bearing holder includes a connector recessed portion recessed radially inward from the radially outer side of the bearing flange portion, and
the resin wall portion is located in the connector recessed portion.

19-23. (canceled)
